(19) United States
(12) Patent Application Publication
(10) Pub. No.: US 2008/0067335 A1
(43) Pub. Date: Mar. 20, 2008

(54) METHOD OF MOVING BUBBLES

(76) Inventors: Ya-Ching Hou, Tai-Chung City (TW); Huan-Ting Tseng, Kao-Hsiung Hsien (TW); Benjamin Szu-Min Lin, Tai-Nan City (TW); Bo-Jou Lu, Tainan Hsien (TW); Yong-Fa Huang, Yun-Lin Hsien (TW); Chun-Chi Yu, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/457,816

(22) Filed: Jul. 17, 2006

(51) Int. Cl. H05H 3/02

(52) U.S. Cl. 250/251

(57) ABSTRACT

A method of moving bubbles includes utilizing optical tweezers to form a bright photoresist area and a dark photoresist area in the photoresist layer. The bubbles in the photoresist layer move from the bright photoresist area to the dark photoresist area.

### BACKGROUND OF THE INVENTION

1. Field of the Invention

The present invention relates to a method of moving bubbles, and more particularly, to a method of moving bubbles in a wafer by utilizing optical tweezers.

2. Description of the Prior Art

Photolithography process is a major technology used in semiconductor manufacturing. As the integration of the scale integration increases, the size of the scale integration decreases. Therefore, an immersion lithography process is researched to apply a minimization process.

The immersion photography process means the exposure process occurs in a liquid. The theory behind the process relates to the fact that the refractive index of liquid is larger than the refractive index of air, and therefore the resolution of the exposure process will increase greatly, achieving minimization. Liquid replaces the air between the lenses and the photoresist layer. Then, light passes through the liquid media in order to shorten the light wavelength, and to improve the resolution. The formula of the light passing through different media is λ′=λ/n, wherein λ′ is the wavelength of light in the liquid media; λis the wavelength of light in air; and n is the refractive index of the liquid media. If the exposure apparatus utilizes a wavelength of 193 nm, and the media between the light source and the semiconductor wafer is pure water (therefore n˜1.43), then the wavelength will decrease to 132 nm.

In general, the semiconductor wafer is processed utilizing an immersion photography process, and a photoresist layer is then spin coated on the semiconductor. Later in the exposure step, photoresist deprotection reaction occurs and produces photo acid, which can diffuse into immersion fluid and fluctuates its PH value, if without the protection from a top coat layer. Therefore, a top coat layer will be coated on the photoresist layer, so as to prevent photo acid from diffusing into the immersion fluid. The chemical liquids of the photoresist layer or the top coat layer contain bubbles, however, and the spin coating process also produces bubbles. The above-mentioned bubbles will influence the continuous exposure process.

In another aspect of the field, bio-technology has recently developed optical tweezers. The optical tweezers comprise a laser, a reflection mirror, and lenses, and can move micro particles. The concept of using the optical tweezers to move bubbles is that when the refractive index of the micro particles is greater than the refractive index of thesurrounded environment, the micro particles will move toward the center of a laser beam (a bright area). Alternatively, when the refractive index of the micro particles is smaller than the refractive index of thesurrounding, the micro particles will move toward the edge of a laser beam (a dark area). In the immersion photography process, the bubbles of the semiconductor wafer have a refractive index that is smaller than the periphery. How to apply the optical tweezers to remove the bubbles in the immersion photography process is an important issue in this field.

### SUMMARY OF THE INVENTION

The present invention relates to a method of moving the bubbles to solve the above-mentioned problems.

An objective of the claimed invention is to provide a method of moving bubbles. A pair of optical tweezers forms a bright photoresist area and a dark photoresist area in the photoresist layer, and the bubbles move from the bright photoresist area to the dark photoresist area.

Another method of moving bubbles is provided. A pair of optical tweezers illuminates the media to form a bright media area and a dark media area, and the bubbles move from the bright media area to the dark media area.

The present invention relates to a pair of optical tweezers illuminating the semiconductor wafer. The major exposure area of the semiconductor becomes a bright area, and the bubbles in the bright area will move toward the dark area, so the exposure process will not be influenced.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1 and 2 schematically illustrate the manufacturing of a first embodiment according to the present invention.

FIG. 3 schematically illustrates the manufacturing of a second embodiment according to the present invention.

FIG. 4 schematically illustrates the manufacturing of a third embodiment according to the present invention.

FIG. 5 schematically illustrates the structure of the stepper exposure apparatus.

FIG. 6 schematically illustrates the manufacturing of a fourth embodiment according to the present invention.

### DETAILED DESCRIPTION

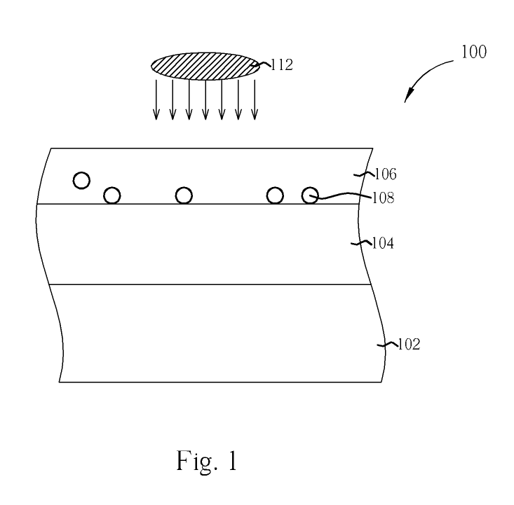

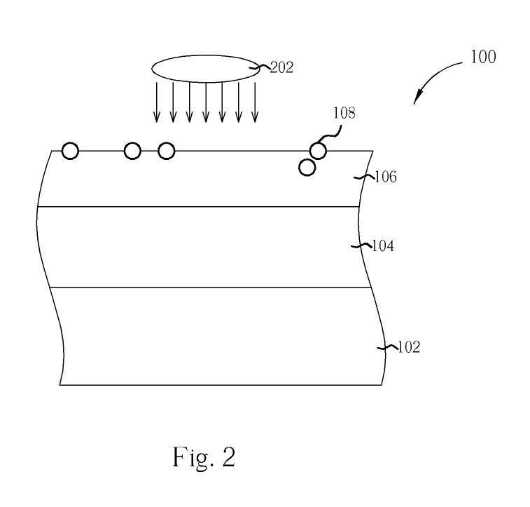

Please refer to FIGS. 1-2. FIGS. 1 and 2 schematically illustrate the manufacturing of the first embodiment according to the present invention. As FIG. 1 shows, a manufacturing substrate is provided, for example a semiconductor wafer 100, being a SOI substrate, glass substrate, quartz substrate or metal substrate. Then, a spin coating process is processed. A photoresist layer 104 is spin coated on the substrate 102 which is the surface of the semiconductor wafer 100. A top coat layer 106 is formed on the surface of the photoresist layer 104 to avoid the photo acid from diffusing into the immersion fluid after exposure step, so the PH of the immersion fluid can be maintained.

The chemical liquids of the photoresist layer 104 or the top coat layer 106 have bubbles originally, or bubbles are formed as a result of the spin coating process. Therefore, after the spin coating process, the surface 102 of the semiconductor wafer 100 will contain some bubbles 108 between the photoresist layer 104 and the top coat layer 106. To avoid the bubbles influencing the exposure result of the semiconductor wafer 100, the first embodiment utilizes a pair of optical tweezers 112 to illuminate the photoresist layer 104. The focus of the optical tweezers 112 is adjusted in order to make the photoresist layer 104 be a bright area, and the top coat layer 106 be a dark area corresponding with the bright area. In other words, the optical tweezers 112 adjust the intensity of the light source, so the light intensity from the photoresist layer 104 to the top coat layer 106 has a gradient from bright to dark. Furthermore, the optical tweezers 112 do not limit the optical tweezers 112 to illuminate from the top of the semiconductor wafer 100 as shown in FIG. 1, but can also illuminate from the lateral side of the semiconductor wafer 100 to the photoresist layer 104 in order to make the photoresist layer 104 be a bright area, and the top coat layer 106 be a dark area corresponding to the bright area.

Please refer to FIG. 2. Because the refractive index of the bubbles 108 is smaller than the refractive index of the environment, the bubbles 108 in the brighter area of the photoresist layer 104 move to the darker area of the protected area under the illumination of the optical tweezers 112. In other words, in the first embodiment, the optical tweezers 112 cause the photoresist layer to be a bright area, and therefore the bubbles 108 in the photoresist layer 104 will move into the dark area of the protected area 106 under the distortion of the optical tweezers 112. Furthermore, the surface of the top coat layer 106 is farthest from the photoresist layer 104, so it will be darkest. In this embodiment, the bubbles of the photoresist layer 104 and the top coat layer 106 will move until they reach the surface of the top coat layer 106. Therefore, the bubbles 108 will not be in the focus of the continuous exposure process and will not influence the whole continuous exposure process. After removing the bubbles 108 away from the photoresist layer 104, the photoresist layer 104 is processed by a baking process. Then, the semiconductor wafer 100 is illuminated by an ArF laser 202 from an ArF scanner (not shown), so as to process the immersion photography.

Please note the top coat layer 106 can be coated with a basic liquid, which dissolves in the media of the immersion photography, or can be coated with a basic liquid, which can be removed after development, e.g. water etc. If the top coat layer 106 has this basic liquid, then the bubbles 108 can move to the surface of the basic liquid being a further distance from the photoresist layer 104, with the aid of the optical tweezers 112. In this way, the bubbles 108 will not influence the continuous exposure process. In Nature, Vol. 424, pages 810-816, D. G. Grier mentioned, the optical tweezers 112 can disturb bubbles having a diameter ranging from 5 nm to a few microns.

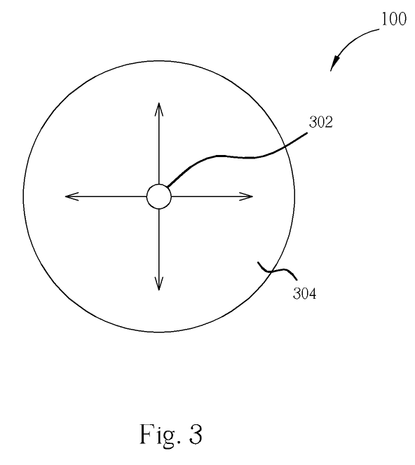

The above-mentioned first embodiment where the optical tweezers 112 cause the photoresist layer 104 be a bright area, and the top coat layer 106 to be a corresponding dark area is not the only embodiment of the present invention. The present invention supports other modifications. Please refer to FIG. 3. FIG. 3 schematically illustrates the manufacturing of the second embodiment according to the present invention. The semiconductor wafer 100 or SOI substrate, glass substrate, quartz substrate, or metal substrate is provided firstly. Then, at least one spin coating process is processed in order to coat the photoresist layer, the top coat layer, and the basic liquid on the semiconductor wafer 100. As FIG. 3 shows, optical tweezers (not shown) illuminate the centre of the semiconductor wafer 100, so the centre of the semiconductor wafer 100 becomes a bright area 302, and the other parts, which are not illuminated by the optical tweezers, become a dark area 304. Therefore, the bubbles (not shown) in the bright area 302 are moved to the dark area 304. Then, the illuminated area of the optical tweezers is adjusted in order to expand in concentric circles or in concentric rings to the edge of the wafer. In other words, the bubbles will move to the edge of the semiconductor wafer 100, and will not move to the area which influences the exposure process.

Furthermore, in the second embodiment, the optical tweezers can illuminate the surface of the semiconductor wafer 100, so the light intensity of the optical tweezers from the centre to the edge has a gradient from bright to dark. The centre of the semiconductor wafer 100 is the brightest part of the bright area 302, and the periphery forms a dark area 304, which has a gradient from bright to dark. Therefore, the optical tweezers disturbs the bubbles, and the bubbles (not shown) in the bright area 302 move toward the dark area 304. The bubbles reach the edge of the semiconductor wafer 100, and will not influence the exposure process. Besides, the bubbles have great floating powers, the bubbles move toward the liquid surface, when the optical tweezers disturbs them.

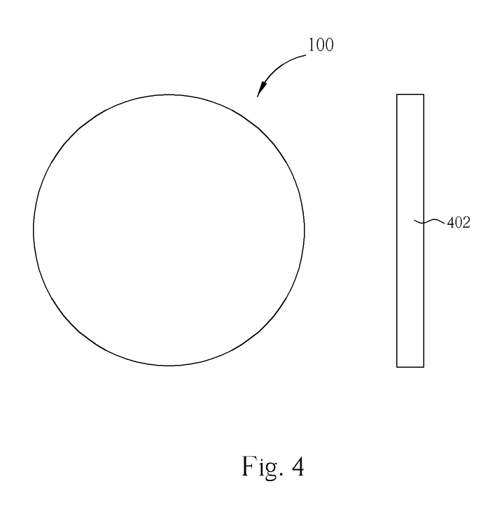

The present invention is not limited to utilize the circle light source of the optical tweezers. Instead, a bar light source can be utilized by scanning. Please refer to FIG. 4. FIG. 4 schematically illustrates the manufacturing of the third embodiment according to the present invention. The semiconductor wafer 100 or SOI substrate, glass substrate, quartz substrate, or metal substrate is provided firstly. Then, at least one spin coating process is processed in order to coat the photoresist layer, the top coat layer, and the basic liquid on the semiconductor wafer 100. A pair of optical tweezers 402 has a bar light source provided in one lateral side of the semiconductor wafer 100, e.g. the right lateral side. Then, the semiconductor wafer 100 moves toward the optical tweezers 402, or the optical tweezers 402 move toward the semiconductor wafer 100, so as to form a bright area of the semiconductor wafer 100 by the optical tweezers 402 illumination and to form a corresponding dark area without the optical tweezers 402 illumination. The bubbles (not shown) in the semiconductor wafer 100 move into the dark area from the right side to the left side. Furthermore, a plurality of optical tweezers 402 each having a bar light source can be utilized in the third embodiment, the plurality of optical tweezers 402 being parallel with each other and formed in one side of the semiconductor 100. Then, the semiconductor wafer 100 moves to the optical tweezers 402, or the optical tweezers 402 scan the semiconductor wafer 100, so the bubbles of the semiconductor wafer 100 move to the other side of the semiconductor wafer 100. Moreover, a plurality of optical tweezers 402 having bar light sources can be utilized in the third embodiment, the plurality of optical tweezers 402 not being parallel with each other, and being formed in at least two sides of the semiconductor 100. Then, the bar light sources of the optical tweezers scan the substrate individually in order to move the bubbles.

Please notice the embodiments shown in FIGS. 1 to 4 apply to the photoresist layer, the top coat layer, and basic liquid on the surface of the manufacturing substrate of the semiconductor wafer having bubbles. If, however, the present invention is applied to removing the bubbles in the photoresist layer, the laser wavelength of the optical tweezers will be different from the exposure wavelength of the photoresist layer in each embodiment. For example, immersion photography usually utilizes ArF for the exposure light source, having an exposure wavelength of 193 nm, whether the wavelength of the optical tweezers is longer than 193 nm. But, the wavelength of the optical tweezers is not limited to be longer than 193 nm. The wavelengths, which are incapable of triggering photochemistry of the 193 nm photoresist layer and leave no damage to the semiconductor wafer, can be applied to the present invention. The present invention is not limited to the above-mentioned embodiments, and not only can move the bubbles in the photoresist layer, and the top coat layer, but can also move the bubbles in the immersion fluid.

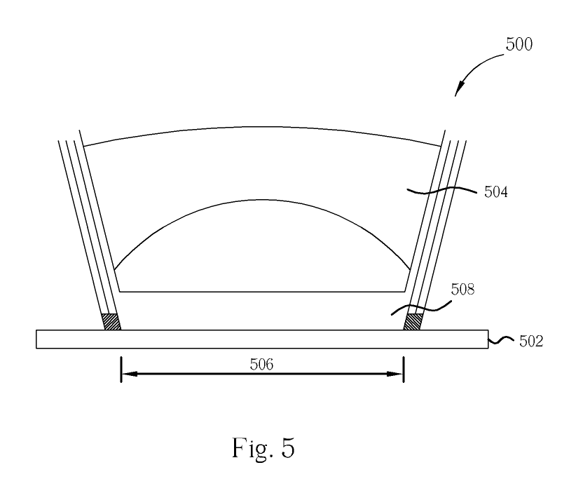

Please refer to FIG. 5. FIG. 5 schematically illustrates the structure of the stepper exposure apparatus. As is well known, the stepper exposure apparatus, e.g. an ArF exposure apparatus 500, processes an immersion photography process for a semiconductor wafer 502. The ArF exposure apparatus 500 has a lens 504, and the area of the semiconductor wafer 502 under the lens 504 is the exposure area 506 in the ArF exposure apparatus 500. The surface of the semiconductor wafer 502 has a photoresist layer and a top coat layer to be exposed. A media 508 lies between the semiconductor wafer 502 in the exposure area 506 and the ArF exposure apparatus 500. Then, the immersion photography is processed.

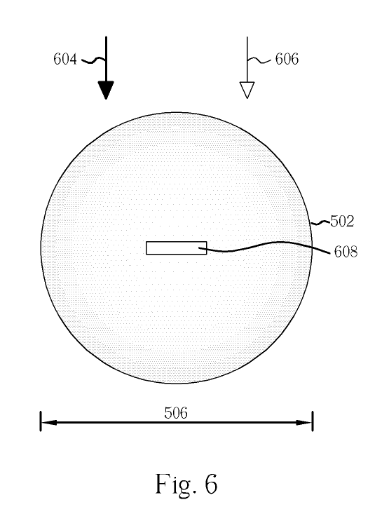

Please refer to FIG. 6. FIG. 6 schematically illustrates the manufacturing of the fourth embodiment according to the present invention. The semiconductor wafer 502 shown in FIG. 6 is a top view of the semiconductor wafer 502 in the exposure area 506 in FIG. 5. As FIG. 6 shows, when an ArF laser of ArF 606 exposure apparatus (not shown) in the present invention processes the exposure process to exposure pattern region 608 of the semiconductor wafer 502, optical tweezers 604 illuminate a laser to move the bubbles in the media. The area, which is beamed by the tweezers 604, is larger than the exposure area 506. In the fourth embodiment, the light intensity of the optical tweezers 604 causes the centre of the semiconductor wafer 502 to be the brightest area, and the periphery of the semiconductor wafer 502 has a gradient from bright to dark. This causes the bubbles in the centre of the semiconductor wafer 502 to move to the dark area of the periphery. The bubbles move away from the centre of the exposure area. The optical tweezers 604 still illuminate the semiconductor wafer 502 during the whole exposure process. Therefore, if any bubbles are large enough for the optical tweezers to move them, the bubbles will move to the edge, so there will be no bubbles to influence the exposure process.

Please note that the laser wavelength of the optical tweezers 604 in the fourth embodiment is different from the exposure wavelength of the immersion photography process. For example, the immersion photography usually utilizes ArF for exposure light, its exposure wavelength being 193 nm, and the wavelength of the optical tweezers being longer than 193 nm. The optical tweezers will not influence the exposure process and therefore, the fourth embodiment can move the bubbles and achieve the exposure process at the same time, without decreasing throughput of semiconductor manufacturing.

The present invention is not limited to the above-mentioned embodiments, however. When the semiconductor wafer is processed by immersion photography, the optical tweezers can illuminate the media at the same time, as in the first embodiment, and the bubbles inside the media will rise. Another modification can use the bar light source of the optical tweezers, as in the third embodiment, and move the bubbles of the media, when the exposure is processed. These modifications all belong to the scope of the present invention.

In summation, the present invention utilizes optical tweezers to illuminate the semiconductor wafer, causing the main exposure area to form a bright area, and the bubbles in the bright area to move to the corresponding dark area. In this way, the exposure process will not be influenced by the bubbles. Otherwise, the present invention can utilize the methods disclosed in the first and third embodiments, and move the bubbles in the photoresist layer, the top coat layer or the basic liquid on the semiconductor wafer firstly. Then, the method disclosed in the fourth embodiment can be utilized to move the bubbles in the media of the immersion photography process, so as to increase the yield of the semiconductor manufacture.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of moving bubbles, the bubbles being in a photoresist layer, the method comprising:
utilizing optical tweezers to form a bright photoresist area and a dark photoresist area in the photoresist layer, wherein the bubbles move from the bright photoresist area to the dark photoresist area.

2. The method of claim 1, wherein after the bubbles move to the photoresist darkness area, the method further comprises:
processing a backing process to the photoresist layer; and
processing an immersion photography to the photoresist layer, wherein a wavelength of the optical tweezers is longer than an exposure wavelength of the immersion photograghy.

3. The method of claim 2, wherein the bright photoresist area is in a centre of the photoresist layer, and the light intensity of the optical tweezers from the bright photoresist area to the periphery has a gradient from bright to dark in order to form the dark photoresist area.

4. The method of claim 2, wherein the optical tweezers have a bar structure, and the optical tweezers move towards the photoresist layer in order to form the bright photoresist area and the dark photresist area.

5. The method of claim 2, further comprising:
providing a top coat layer on the photoresist layer.

6. The method of claim 5, wherein when the bright photoresist area is formed by the optical tweezers, a protected dark area is formed in the top coat layer at the same time, so as the bubbles in the bright photoresist area move to the protected dark area.

7. The method of claim 6, wherein a light intensity of the optical tweezers from the bright photoresist area to the top coat layer has a gradient from bright to dark in order to form a protected dark area.

8. A method of moving bubbles, the bubbles being in a media of an immersion photography process, the method comprising:
utilizing optical tweezers to illuminate the media to form a bright media area and a dark media area, wherein the bubbles move from the bright media area to the dark media area.

9. The method of claim 8, wherein the media is water.

10. The method of claim 8, wherein the bright media area is in a centre of the media, and a light intensity of the optical tweezers from the bright media area to the periphery has a gradient from bright to dark in order to form the dark media area.

11. The method of claim 8, wherein a wavelength of the optical tweezers is longer than an exposure wavelength of the immersion photography process.

12. The method of claim 11, wherein the wavelength of the optical tweezers is longer than 193 nm.

13. A method of moving bubbles, the bubbles being in a wafer, the method comprising:
utilizing optical tweezers on the wafer in order to form a bright wafer area and a dark wafer area, wherein the bubbles move from the bright wafer area to the dark wafer area.

14. The method of claim 13, wherein the wafer comprises a photoresist layer.

15. The method of claim 13, wherein the wafer is processed by an immersion photography process.

16. The method of claim 15, wherein a wavelength of the optical tweezers is longer than an exposure wavelength of the immersion photography process.

17. The method of claim 16, wherein the wavelength of the optical tweezers is longer than 193 nm.
